(19) United States
(12) Patent Application Publication
(10) Pub. No.: US 2016/0127984 A1
(43) Pub. Date: May 5, 2016

(54) ELECTRONIC DEVICE AND METHOD FOR SEARCHING NETWORK CARRIER

(71) Applicant: Chiun Mai Communication Systems, Inc., New Taipei (TW)

(72) Inventor: LIANG-CHENG LIAO, New Taipei (TW)

(21) Appl. No.: 14/688,533

(22) Filed: Apr. 16, 2015

(30) Foreign Application Priority Data
Nov. 5, 2014 (CN) 201410619420.8

(51) Int. Cl. H04W 48/18; H04W 76/02

(52) U.S. Cl. CPC H04W 48/18; H04W 76/02

(57) ABSTRACT

A method for searching network carrier using an electronic device includes receiving a request for a voice service from a user. The electronic device requests a server for a network carrier through which the electronic device can be connected to a network providing the voice service. A message is received from the server. When the received message comprises the network carrier, a connection is established between the network and the electronic device using the network carrier. The voice service is provided for the user through the network.

### CROSS-REFERENCE TO RELATED APPLICATIONS

This application claims priority to Chinese Patent Application No. 201410619420.8 filed on Nov. 5, 2014, the contents of which are incorporated by reference herein.

### FIELD

The subject matter herein generally relates to network technology, and particularly to an electronic device and a method for searching network carriers using the electronic device.

### BACKGROUND

A fourth generation of mobile telecommunications technology (4G) network provides data service and cannot provide a voice service. When an electronic device of a user is connected to the 4G network and receives a request for a voice service from the user, the electronic device has to search for a second generation of mobile telecommunications technology (2G) network or a third generation of mobile telecommunications technology (3G) network to respond to the request.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including a search system.

FIG. 2 is a block diagram of one embodiment of function modules of the search system in the electronic device of FIG. 1.

FIG. 3A and FIG. 3B illustrate a flowchart of one embodiment of a method for searching network carriers using the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation.

Several definitions that apply throughout this disclosure will now be presented. It should be noted that references to “an” or “one” embodiment in this disclosure are not necessarily to the same embodiment, and such references mean “at least one.” Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to,” it specifically indicates open-ended inclusion or membership in a so-described combination, group, series and the like.

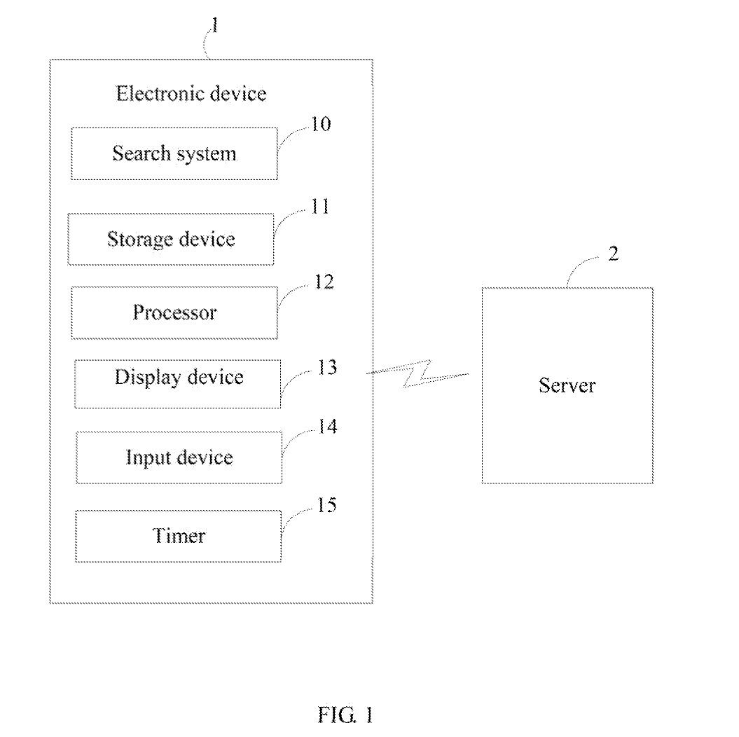

FIG. 1 illustrates a block diagram of one embodiment of an electronic device. In at least one embodiment as shown in FIG. 1, an electronic device 1 is connected to a server 2. The electronic device 1 includes, but is not limited to, a search system 10, a storage device 11, at least one processor 12, a display device 13, an input device 14 and a timer 15. The electronic device 1 can be a tablet computer, a notebook computer, a smart phone, a personal digital assistant (PDA), or another suitable electronic device. FIG. 1 illustrates only one example of the electronic device that can include more or fewer components than illustrated, or have a different configuration of the various components in other embodiments.

In at least one embodiment, when the electronic device 1 receives a request for a voice service, the search system 10 can automatically search for a network carrier through which the electronic device can be connected to a network providing the voice service.

In at least one embodiment, when the electronic device 1 sends a request to the server for a network carrier through which the electronic device 1 can be connected to a network providing the voice service, the server 2 can transmits a response message for the electronic device 1.

In at least one embodiment, the storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium. The at least one processor 12 can be a central processing unit (CPU), a microprocessor, or other data processor chip that performs functions of the search system 10 in the electronic device 1. The display device 13 can display images and videos, and the input device 14 can be a mouse, a keyboard, or a touch panel.

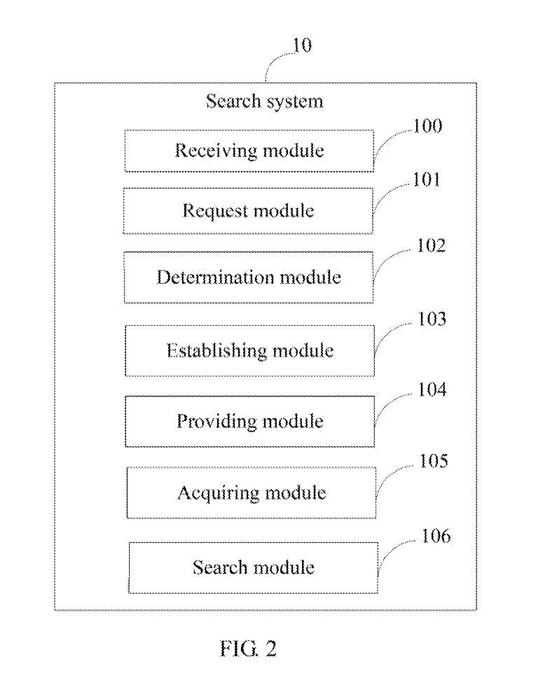

FIG. 2 is a block diagram of one embodiment of function modules of the search system. In at least one embodiment, the search system 10 can include a receiving module 100, a request module 101, a determination module 102, an establishing module 103, a providing module 104, an acquiring module 105 and a search module 106. The function modules 100, 101, 102, 103, 104, 105 and 106 can include computerized codes in the form of one or more programs, which are stored in the storage device 11. The at least one processor 12 executes the computerized codes to provide functions of the function modules 100-106.

When a user selects a request for a voice service, for example, the user dials a telephone number, the receiving module 100 receives the request for the voice service.

The request module 101 sends the request to the server 2 for a network carrier through which the electronic device 1 can be connected to a network providing the voice service. In at least one embodiment, the request module 101 sets a search duration according to the request for the voice service, and starts a timer 15 of the electronic device 1.

In at least one embodiment, the network carrier can be one of network carriers including a second generation of mobile telecommunications technology (2G) network or a third generation of mobile telecommunications technology (3G) network. The 2G network includes a plurality of network bands. Each of the network bands of the 2G network includes a plurality of network carriers of the 2G network. The 3G network includes a plurality of network bands. Each of the network bands of the 3G network includes a plurality of network carriers of the 3G network. For example, the China Unicom telecom company provides a Wideband Code Division Multiple Access (WCDMA) of a network model of the 3G network. The WCDMA can include a network band from 1920 to 1980 mhz and another network band from 2110 to 2170 mhz. The network band from 1920 to 1980 mhz includes network carriers, such as 10713, 10688 and 10663. The another network band from 2110 to 2170 mhz includes network carriers, such as 9763, 9738 and 9713.

The server 2 receives the request from the electronic device 1 and transmits a response message based on the request. The receiving module 100 receives the response message from the server 2.

The determination module 102 determines whether the received response message includes a network carrier. In at least one embodiment, when the received response message includes the network carrier, the establishing module 103 establishes a connection between the network and the electronic device using the network carrier. The providing module 104 provides the voice service for the user through the network.

In at least one embodiment, candidate network carriers are pre-stored in the storage device 11 of the electronic device 1. When the received response message includes no network carrier, the acquiring module 105 acquires the candidate network carriers from the storage device 11.

The search module 106 searches the candidate carriers for a specified network carrier through which the electronic device 1 can be connected to the network. When one of the candidate carriers can be used to connect the electronic device 1 to the network, the search module 106 determines this candidate carrier, which is connected the electronic device 1 to the network, to be the specified network carrier. When the specified network carrier is found, the establishing module 103 establishes the connection between the network and the electronic device 1 using the specified network carrier. The providing module 104 provides the voice service for the user through the network.

In at least one embodiment, a plurality of network bands are pre-stored in the storage device 11. When no specified network carrier is found among the candidate carriers, the search module 106 can do a further search for the specified network carrier according to the network bands pre-stored in the storage device 11. The acquiring module 105 acquires the network bands from the storage device 11. According to the acquired network bands, the search module 106 searches the specified network carrier through which the electronic device can be connected to the network. When one of the network carriers included in the network bands can be used to connect the electronic device 1 to the network, the search module 106 determines this network carrier, which is connected the electronic device 1 to the network, to be the specified network carrier. When the specified network carrier is found, the establishing module 103 establishes the connection between the network and the electronic device using the specified network carrier. The providing module 104 provides the voice service for the user through the network.

In at least one embodiment, when the specified carrier cannot be found according to the network bands pre-stored in the storage device 11, the determination module 102 stops the timer 15 and determines a duration computed by the timer. The determination module 102 determines whether the determined duration is longer than the search duration. When the determined duration is longer than the search duration, the providing module 104 provides a message that indicates no network carrier is determined. When the determined duration is shorter than or equal to the search duration, the searching module 106 re-searches the specified network carrier through which the electronic device 1 can be connected to the network according to the acquired network bands.

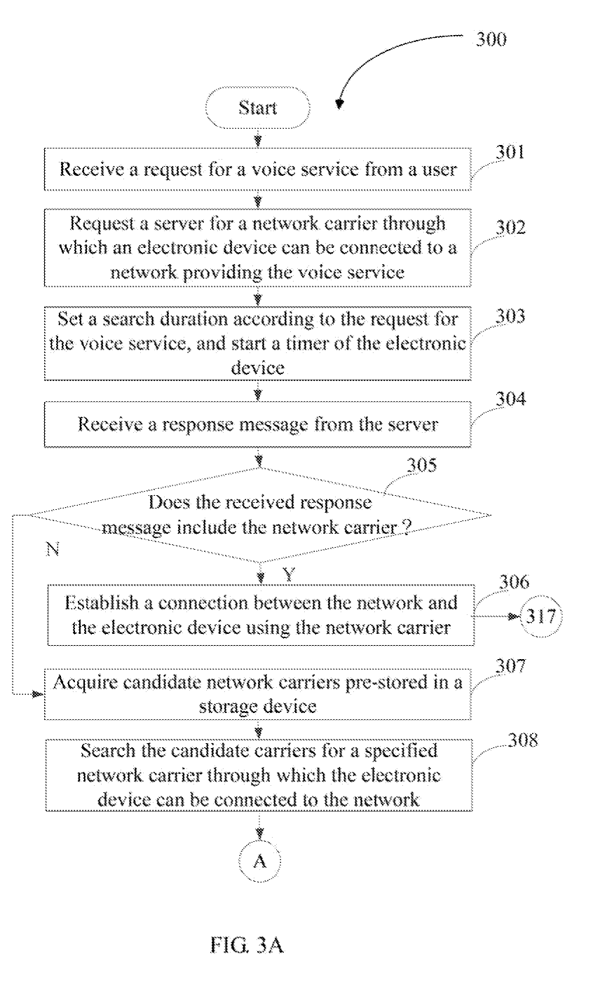

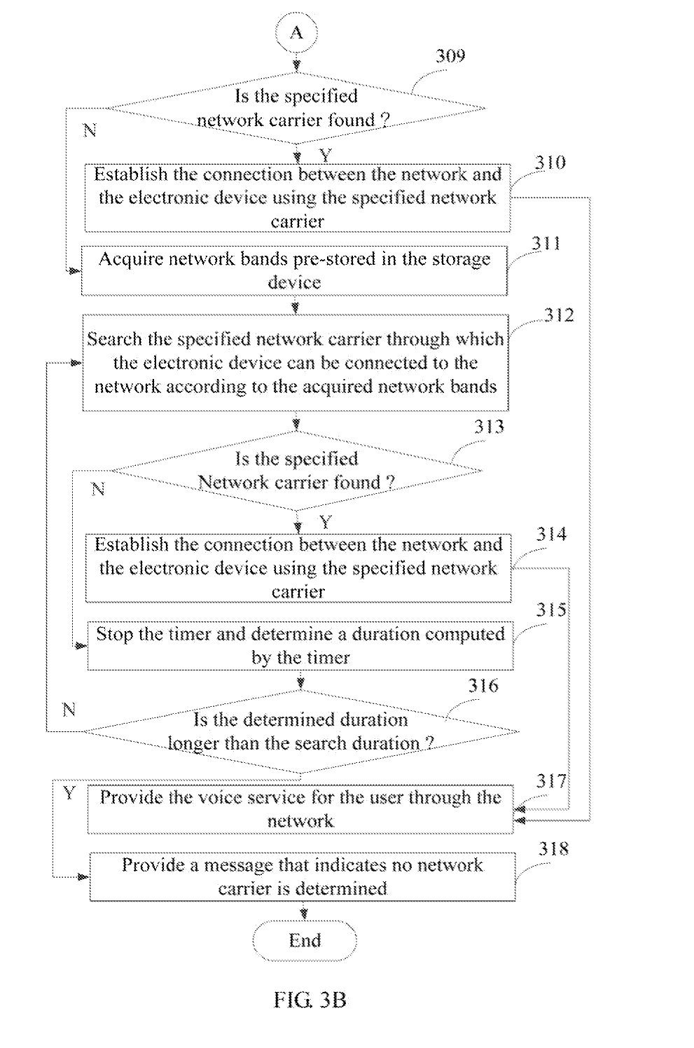

FIG. 3A and FIG. 3B illustrate a flowchart is presented in accordance with an example embodiment. An example method 300 is provided by way of example, as there are a variety of ways to carry out the method. The example method 300 described below can be carried out using the configurations illustrated in FIGS. 1 and 2 for example, and various elements of these figures are referenced in explaining example method 300. Each block shown in FIG. 3A and FIG. 3B, represent one or more processes, methods, or subroutines carried out in the example method 300. Furthermore, the illustrated order of blocks is illustrative only and the order of the blocks can be changed according to the present disclosure. The example method 300 can begin at block 301. Depending on the embodiment, additional blocks may be utilized and the ordering of the blocks can be changed.

At block 301, when a user selects a request for a voice service, for example, the user dials a telephone number, a receiving module receives the request for the voice service.

At block 302, a request module sends a request to a server for a network carrier through which an electronic device can be connected to a network providing the voice service.

At block 303, the request module sets a search duration according to the request for the voice service, and starts a timer of the electronic device.

In at least one embodiment, the network carrier can be one of network carriers including a second generation of mobile telecommunications technology (2G) network or a third generation of mobile telecommunications technology (3G) network. The 2G network includes a plurality of network bands. Each of the network bands of the 2G network includes a plurality of network carriers of the 2G network. The 3G network includes a plurality of network bands. Each of the network bands of the 3G network includes a plurality of network carriers of the 3G network. For example, the China Unicom telecom company provides a Wideband Code Division Multiple Access (WCDMA) of a network model of the 3G network. The WCDMA can include a network band from 1920 to 1980 mhz and another network band from 2110 to 2170 mhz. The network band from 1920 to 1980 mhz includes network carriers, such as 10713, 10688 and 10663. The another network band from 2110 to 2170 mhz includes network carriers, such as 9763, 9738 and 9713.

At block 304, the server receives the request from the electronic device and transmits a response message based on the request. The receiving module receives the response message from the server.

At block 305, an determination module determines whether the received response message includes a network carrier. In at least one embodiment, when the received response message includes the network carrier, a procedure goes to a block 306, the establishing module 103 establishes a connection between the network and the electronic device using the network carrier. Then the procedure goes to a block 317, a providing module provides the voice service for the user through the network.

In at least one embodiment, candidate network carriers are pre-stored in a storage device of the electronic device. When the received response message includes no network carrier, the procedure goes to block 307, an acquiring module acquires the candidate network carriers from the storage device.

At block 308, a search module searches the candidate carriers for a specified network carrier through which the electronic device can be connected to the network.

At block 309, the search module determines whether the specified network carrier is found. When one of the candidate carriers can be used to connect the electronic device to the network, the search module determines this candidate carrier, which is connected the electronic device to the network, to be the specified network carrier. When the specified network carrier is found, the procedure goes to block 310, the establishing module establishes the connection between the network and the electronic device using the specified network carrier. Then the procedure goes to block 317, the providing module provides the voice service for the user through the network.

In at least one embodiment, a plurality of network bands are pre-stored in the storage device. When no specified network carrier is found among the candidate carriers, the procedure goes to block 311, the search module can do a further search for the specified network carrier according to the network bands pre-stored in the storage device.

At block 311, the acquiring module acquires the network bands from the storage device.

At block 312, according to the acquired network bands, the search module searches the specified network carrier through which the electronic device can be connected to the network.

At block 313, the search module determines whether the specified network carrier is found according to the acquired network bands. When one of the network carriers included in the network bands can be used to connect the electronic device to the network, the search module determines this network carrier, which is connected the electronic device to the network, to be the specified network carrier. When the specified network carrier is found, the procedure goes to block 314, the establishing module establishes the connection between the network and the electronic device using the specified network carrier. Then the procedure goes to block 317, the providing module provides the voice service for the user through the network.

In at least one embodiment, when the specified carrier cannot be found according to the network bands pre-stored in the storage device, the procedure goes to block 315, the determination module stops the timer and determines a duration computed by the timer.

At block 316, the determination module determines whether the determined duration is longer than the search duration. When the determined duration is longer than the search duration, the procedure goes to block 318, the providing module 104 provides a message that indicates no network carrier is determined. When the determined duration is shorter than or equal to the search duration, the procedure goes to block 312.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for searching network carrier using an electronic device being executed by a processor of the electronic device, the electronic device being connected to a server, the method comprising:
receiving a request for a voice service from a user;
requesting the server for a network carrier through which the electronic device can be connected to a network providing the voice service;
receiving a response message from the server;
establishing a connection between the network and the electronic device using the network carrier when the received response message comprises the network carrier; and
providing the voice service for the user through the network.

2. The method according to claim 1, further comprising:
acquiring candidate network carriers pre-stored in a storage device of the electronic device when the received response message comprises no network carriers through which the electronic device can be connected to the network;
searching the candidate carriers for a specified network carrier through which the electronic device can be connected to the network; and
establishing the connection between the network and the electronic device using the specified network carrier when the specified network carrier is found.

3. The method according to claim 2, further comprising:
acquiring network bands pre-stored in the storage device when no specified carrier is found;
searching the specified network carrier according to the acquired network bands; and
establishing the connection between the network and the electronic device using the specified network carrier when the specified network carrier is found according to the acquired network bands.

4. The method according to claim 3, further comprising:
setting a search duration according to the request for the voice service, and starting a timer of the electronic device while starting to request the server for the network carrier;
stopping the timer when the another specified carrier is not found according to the acquired network bands;
determining a duration computed by the timer; and
providing a message that indicates no network carrier is determined when the determined duration is longer than the search duration.

5. An electronic device, comprising:
at least one processor; and
a storage device that stores one or more programs, the electronic device being connected to a server, when executed by the at least one processor, cause the at least one processor to:
receive a request for a voice service from a user;
request the server for a network carrier through which the electronic device can be connected to a network providing the voice service;
receive a response message from the server;
establish a connection between the network and the electronic device using the network carrier when the received response message comprises the network carrier; and
provide the voice service for the user through the network.

6. The electronic device according to claim 5, wherein the at least one processor further:
acquires candidate network carriers pre-stored in a storage device of the electronic device when the received response message comprises no network carriers through which the electronic device can be connected to the network;
searches the candidate carriers for a specified network carrier through which the electronic device can be connected to the network; and establishes the connection between the network and the electronic device using the specified network carrier when the specified network carrier is found

7. The electronic device according to claim 6, wherein the at least one processor further:
acquires network bands pre-stored in the storage device when no specified carrier is found;
searches the specified network carrier according to the acquired network bands; and
establishes the connection between the network and the electronic device using the specified network carrier when the specified network carrier is found.

8. The electronic device according to claim 7, wherein the at least one processor further:
sets a search duration according to the request for the voice service, and starts a timer of the electronic device while starting to request the server for the network carrier;
stops the timer when the another specified carrier is not found according to the acquired network bands;
determines a duration computed by the timer; and
provides a message that indicates no network carrier is determined when the determined duration is longer than the search duration.

9. A non-transitory storage medium having stored thereon instructions that, when executed by a processor of an electronic device, causes the processor to perform a search method, the electronic device being connected to a server, wherein the method comprises:
receiving a request for a voice service from a user;
requesting the server for a network carrier through which the electronic device can be connected to a network providing the voice service;
receiving a response message from the server;
establishing a connection between the network and the electronic device using the network carrier when the received response message comprises the network carrier; and
providing the voice service for the user through the network.

10. The non-transitory storage medium according to claim 9, wherein the method further comprises:
acquiring candidate network carriers pre-stored in a storage device of the electronic device when the received response message comprises no network carriers through which the electronic device can be connected to the network;
searching the candidate carriers for a specified network carrier through which the electronic device can be connected to the network; and
establishing the connection between the network and the electronic device using the specified network carrier when the specified network carrier is found.

11. The non-transitory storage medium according to claim 10, wherein the method further comprises:
acquiring network bands pre-stored in the storage device when no specified carrier is found;
searching the specified network carrier according to the acquired network bands; and
establishing the connection between the network and the electronic device using the specified network carrier when the specified network carrier is found according to the acquired network bands.

12. The non-transitory storage medium according to claim 11, wherein the method further comprises:
setting a search duration according to the request for the voice service, and starting a timer of the electronic device while starting to request the server for the network carrier;
stopping the timer when the specified carrier is not found according to the acquired network bands;
determining a duration computed by the timer; and
providing a message that indicates no network carrier is determined when the determined duration is longer than the search duration.
